(19) United States
(12) Patent Application Publication
(10) Pub. No.: US 2026/0145462 A1
(43) Pub. Date: May 28, 2026

(54) DRIVE DEVICE OF RIGID-AXLE ELECTRIFIED VEHICLE

(71) Applicant: TOYOTA JIDOSHA KABUSHIKI KAISHA, Toyota-shi (JP)

(72) Inventors: Masato FUJIKAWA, Susono-shi (JP); Motoaki KIMURA, Nagoya-shi (JP)

(73) Assignee: TOYOTA JIDOSHA KABUSHIKI KAISHA, Toyota-shi (JP)

(21) Appl. No.: 19/401,740

(22) Filed: Nov. 26, 2025

(30) Foreign Application Priority Data
Nov. 28, 2024 (JP) 2024-207773

(51) Int. Cl. B60B 35/12; B60B 35/16; B60G 5/00; B60G 11/04; B60G 11/14; B60K 1/00; B60K 17/16; F16H 37/08; F16H 57/02; F16H 57/021; F16H 57/037; F16H 57/04

(52) U.S. Cl. CPC B60B 35/125; B60B 35/128; B60B 35/16; B60G 5/00; B60G 11/04; B60G 11/14; B60K 1/00; B60K 17/165; F16H 37/0813; F16H 57/021; F16H 57/037; F16H 57/0483; B60G 2202/112; B60G 2202/12; F16H 2057/02034; F16H 2057/02052

(57) ABSTRACT

A drive device of a rigid-axle electrified vehicle includes an electromotive drive unit, a final speed reducer, an axle housing, and a transmission shaft. The electromotive drive unit is provided in a vehicle body. The final speed reducer divides dynamic power from the electromotive drive unit to right and left drive wheels. The axle housing couples the right and left drive wheels and houses the final speed reducer. The transmission shaft transmits dynamic power from the electromotive drive unit to the final speed reducer. The axle housing supports the vehicle body through a suspension spring. The transmission shaft is disposed in a vehicle-width direction. A first end of the transmission shaft in the vehicle-width direction is coupled to the electromotive drive unit through a first joint. A second end of the transmission shaft in the vehicle-width direction is coupled to the final speed reducer through a second joint.

### CROSS-REFERENCE TO RELATED APPLICATION

This application claims priority to Japanese Patent Application No. 2024-207773 filed on Nov. 28, 2024. The disclosure of the above-identified application, including the specification, drawings, and claims, is incorporated by reference herein in its entirety.

### BACKGROUND

### 1. Technical Field

The present disclosure relates to a drive device of a rigid-axle electrified vehicle in which right and left drive wheels are coupled by an axle housing.

### 2. Description of Related Art

As a kind of vehicle that has an axle suspension and in which an axle pipe coupling right and left drive wheels, that is, an axle housing is connected to a vehicle body through a coil spring or a leaf spring, there is known a rigid-axle electrified vehicle that houses a final speed reduction device and a driveshaft in an axle housing. For example, there is a drive device of an electrified vehicle described in Japanese Unexamined Patent Application Publication No. 9-240296 (JP 9-240296 A).

### SUMMARY

In electrified vehicles, it is necessary to provide a space where a traveling battery is equipped, for the securement of a cruising distance, and it is desirable to dispose the traveling battery under a floor, for both sizes of a vehicle cabin and a luggage room.

However, in the drive device of the electrified vehicle described in JP 9-240296 A, an electrical motor that drives, through a transmission shaft, an input bevel gear that engages with a large-diameter bevel gear of a final speed reduction device is disposed such that a rotation center line of a rotor of the electrical motor extends in a front-rear direction of the electrified vehicle. Therefore, the underfloor space of the vehicle body is occupied by the electrical motor and the transmission shaft, and a space for disposing the traveling battery is not sufficiently obtained in the underfloor space.

The present disclosure provides a drive device of a rigid-axle electrified vehicle that makes it possible to sufficiently obtain the space for disposing the traveling battery, under the floor the vehicle body.

An aspect of the present disclosure relates to a drive device of a rigid-axle electrified vehicle that includes an electromotive drive unit, a final speed reducer, an axle housing, and a transmission shaft. The electromotive drive unit is provided in a vehicle body. The final speed reducer is configured to divide dynamic power from the electromotive drive unit to right and left drive wheels. The axle housing is configured to couple the right and left drive wheels and to house the final speed reducer. The transmission shaft is configured to transmit dynamic power from the electromotive drive unit to the final speed reducer. The axle housing is configured to support the vehicle body through a suspension spring. The transmission shaft is disposed in a vehicle-width direction of the vehicle body. A first end of the transmission shaft in the vehicle-width direction is coupled to the electromotive drive unit through a first joint. A second end of the transmission shaft in the vehicle-width direction is coupled to the final speed reducer through a second joint.

In the drive device of the rigid-axle electrified vehicle in the above aspect, the transmission shaft that transmits dynamic power from the electromotive drive unit to the final speed reducer is disposed in the vehicle-width direction, the first end of the transmission shaft in the vehicle-width direction is coupled to the electromotive drive unit through the first joint, and the second end of the transmission shaft in the vehicle-width direction is coupled to the final speed reducer through the second joint. Thereby, in the rigid-axle electrified vehicle, the transmission shaft is disposed in the vehicle-width direction, and therefore, a space for disposing a traveling battery is sufficiently obtained under a floor of the vehicle body, compared to a case where the transmission shaft is disposed in a vehicle front-rear direction.

In the drive device of the rigid-axle electrified vehicle in the aspect of the present disclosure, the suspension spring may be a pair of coil springs. Movement of the axle housing in the vehicle-width direction may be restricted by a lateral rod, a first end of the lateral rod in the vehicle-width direction being coupled to the vehicle body, a second end of the lateral rod in the vehicle-width direction being coupled to the axle housing. Moreover, the lateral rod and the transmission shaft may be configured to pivot in an identical direction in connection with vertical motion of the vehicle body.

In the drive device of the rigid-axle electrified vehicle that has the above configuration, the suspension spring is constituted by the coil springs, and the movement of the axle housing in the vehicle-width direction is restricted by the lateral rod in which the first end in the vehicle-width direction is coupled to the vehicle body and the second end in the vehicle-width direction is coupled to the axle housing. Moreover, the lateral rod and the transmission shaft pivot in an identical direction in connection with the vertical motion of the vehicle body. Thereby, for both of the lateral rod and the transmission shaft, the first ends in the vehicle-width direction are supported by a spring-upper member, and the second ends are supported by a spring-lower member. Therefore, the extension-contraction amount of the first joint or second joint provided on the transmission shaft is reduced, and durability is obtained. Further, there is an advantage in that the axis-directional size of an outer race of the first joint or second joint decreases and a maximal crossing angle increases.

In the drive device of the rigid-axle electrified vehicle in the aspect of the present disclosure, the final speed reducer may include a differential gear mechanism and a speed reduction mechanism. The differential gear mechanism may be configured to distribute dynamic power to the right and left drive wheels through a pair of driveshafts, respectively. The speed reduction mechanism may be a pair of cylindrical gears provided around a rotation axis of the differential gear mechanism and a rotation axis parallel to the rotation axis of the differential gear mechanism, respectively. Moreover, the rotation direction of the transmission shaft is the reverse direction of the rotation direction of the driveshafts.

In the drive device of the rigid-axle electrified vehicle that has the above configuration, the final speed reducer includes the differential gear mechanism that distributes dynamic power to the right and left drive wheels through the driveshafts respectively, and the speed reduction mechanism that is constituted by the cylindrical gears provided around the rotation axis of the differential gear mechanism and the rotation axis parallel to the rotation axis of the differential gear mechanism respectively. Moreover, the rotation direction of the transmission shaft is the reverse direction of the rotation direction of the driveshafts. Thereby, when drive power is generated in a forward movement direction, although a front end of the axle housing moves upward, a rear end of the electromotive drive unit installed on the vehicle body side also moves upward. Therefore, the increase in the height difference of the transmission shaft at the time of vehicle traveling is restrained, and therefore, the deterioration of the first joint and second joint at both ends of the transmission shaft can be restrained.

In the drive device of the rigid-axle electrified vehicle in the aspect of the present disclosure, the final speed reducer may include a differential gear mechanism and a speed reduction mechanism. The differential gear mechanism may be configured to distribute dynamic power to the right and left drive wheels through driveshafts, respectively. The speed reduction mechanism may include a pair of sprockets provided around a rotation axis of the differential gear mechanism and a rotation axis parallel to the rotation axis of the differential gear mechanism, respectively, and a transmission chain wound around the sprockets.

In the drive device of the rigid-axle electrified vehicle that has the above configuration, the final speed reducer includes the speed reduction mechanism constituted by the differential gear mechanism that distributes dynamic power to the right and left drive wheels through the driveshafts respectively, the sprockets that are provided around the rotation axis of the differential gear mechanism and the rotation axis parallel to the rotation axis of the differential gear mechanism respectively, and the transmission chain that is wound around the sprockets. Thereby, tooth flank loss is lower and transmission efficiency is higher, compared to a final speed reducer that uses a hypoid gear.

In the drive device of the rigid-axle electrified vehicle that has the above configuration, the final speed reducer may be lubricated with a lubricant that has a lower viscosity than a hypoid gear lubricant.

In the drive device of the rigid-axle electrified vehicle that has the above configuration, the final speed reducer is lubricated with the lubricant that has a lower viscosity than the hypoid gear lubricant. Thereby, it is possible to use an ATF for the cylindrical gear that has a low viscosity, for the lubrication of the final speed reducer, and to lessen dynamic power loss.

In the drive device of the rigid-axle electrified vehicle that has the above configuration, the final speed reducer may include the a speed reduction mechanism, and the a differential gear mechanism configured to transfer dynamic power from the speed reduction mechanism to the right and left drive wheels through the driveshafts, respectively. The axle housing may include a pair of small-diameter portions configured to house the driveshafts, and a large-diameter portion provided between the small-diameter portions and configured to house the speed reduction mechanism and the differential gear mechanism. Moreover, at least a largest-diameter site of the large-diameter portion may be positioned so as not to overlap with the electromotive drive unit in a vehicle moving direction.

In the drive device of the rigid-axle electrified vehicle that has the above configuration, the axle housing includes the pair of small-diameter portions that house the driveshafts, and the large-diameter portion that is provided between the pair of small-diameter portions and that houses the speed reduction mechanism and the differential gear mechanism, and at least the largest-diameter site of the large-diameter portion is positioned so as not to overlap with the electromotive drive unit in the vehicle moving direction. Thereby, there is an advantage in that a space that is broad as a whole is formed on the electromotive drive unit side of the large-diameter portion and the electromotive drive unit and the transmission shaft are disposed in the space.

In the drive device of the rigid-axle electrified vehicle in the aspect of the present disclosure, the electromotive drive unit may include an electric motor and a speed reducer configured to reduce the speed of rotation of the electric motor. Moreover, the speed reducer may include an input shaft protruded to the side of the electric motor and coupled to the electric motor and an output shaft protruded to the side of the electric motor and coupled to the first end of the transmission shaft in the vehicle-width direction.

In the drive device of the rigid-axle electrified vehicle that has the above configuration, the electromotive drive unit includes the electric motor and the speed reducer that reduces the speed of the rotation of the electric motor, and the speed reducer includes the input shaft protruded to the side of the electric motor and coupled to the electric motor and the output shaft protruded to the side of the electric motor and coupled to the first end of the transmission shaft in the vehicle-width direction. Thereby, in the speed reducer, the dynamic power from the electric motor is turned back, and is transferred to the transmission shaft, and therefore, downsizing can be performed not only in the front-rear direction of the vehicle but also in a right-left direction of the vehicle.

In the drive device of the rigid-axle electrified vehicle in the aspect of the present disclosure, each of the first joint and the second joint may be a constant-velocity joint. Moreover, at least one of the first joint and the second joint may be a sliding constant-velocity joint that is configured to allow slide in an axis direction.

In the drive device of the rigid-axle electrified vehicle that has the above configuration, each of the first joint and the second joint is a constant-velocity joint, and at least one of the first joint and the second joint is a sliding constant-velocity joint that allows slide in the axis direction. Therefore, it is possible to restrain torque variation. In the case where the first joint and the second joint are Cardan joints instead of siding constant-velocity joints, the torque variation is cancelled by disposing one Cardan joint such that the phase angle is shifted by 90° relative to the other Cardan joint. However, in the case where crossing angles at both ends of the transmission shaft are different, the torque variation cannot be cancelled.

In the drive device of the rigid-axle electrified vehicle in the aspect of the present disclosure, the suspension spring may be a pair of leaf springs each of which is constituted by a single plate-shaped spring or a plurality of laminated plate-shaped springs, both end portions of each leaf spring in a longitudinal direction of the leaf spring may be coupled to the vehicle body, and a central portion of each leaf spring in the longitudinal direction being coupled to the axle housing. Moreover, movement of the axle housing in a vertical direction and the vehicle-width direction may be restricted by the leaf springs.

In the drive device of the rigid-axle electrified vehicle that has the above configuration, the suspension spring is a pair of leaf springs each of which is constituted by the single plate-shaped spring or the laminated plate-shaped springs, both end portion of each leaf spring in the longitudinal direction are coupled to the vehicle body, and the central portion of each leaf spring in the longitudinal direction is coupled to the axle housing. Moreover, the movement of the axle housing in the vertical direction and the vehicle-width direction is restricted by the leaf springs. Thereby, the space for disposing the traveling battery is sufficiently obtained under the floor of the vehicle body, compared to the case where the transmission shaft is disposed in the vehicle front-rear direction.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a simplified diagram showing a drive device of a rigid-axle electrified vehicle that includes a suspension device in a first embodiment as an example of the present disclosure;

FIG. 2 is a diagram for describing the action of a suspension drive device in FIG. 1;

FIG. 3 is a perspective view for simplifying and describing the action of the drive device in FIG. 1; and

FIG. 4 is a simplified diagram showing a drive device of a rigid-axle electrified vehicle in a second embodiment of the present disclosure.

### DETAILED DESCRIPTION OF EMBODIMENTS

A first embodiment and second embodiment of the present disclosure will be described below with reference to the drawings. In the first embodiment and second embodiment described below, the figures are simplified or modified when appropriate, and dimensional ratios, shapes and others of parts are not always exactly illustrated.

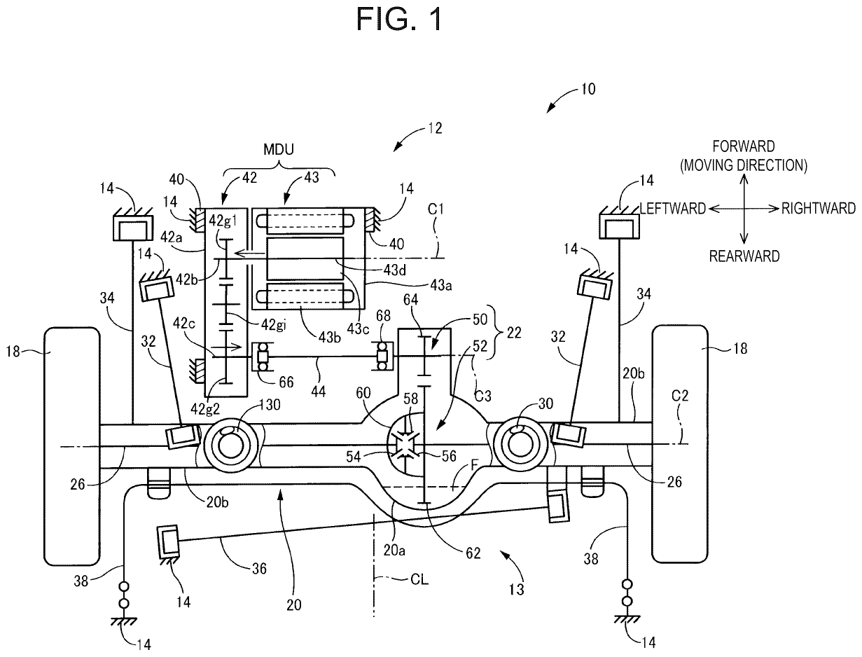

FIG. 1 is a diagram for describing the configuration of a drive device 12 of a rigid-axle electrified vehicle (referred to as an electrified vehicle, hereinafter) 10 in the first embodiment of the present disclosure in a simplified manner. The electrified vehicle 10, which is a rigid type, supports a vehicle body 14 through a suspension device 13 that suspends the vehicle body 14 in a vertically movable manner, and includes an axle housing 20 that is an axle pipe that couples right and left drive wheels 18 as rear wheels or front wheels. The vehicle body 14 corresponds to a spring-upper member, and the axle housing 20 corresponds to a spring-lower member. The axle housing 20 houses a final speed reducer 22 that functions as a final speed reduction device and houses a pair of driveshafts 26.

The suspension device 13 is a well-known five-link type, and includes a coil spring 30, a pair of right and left upper trailing arms 32, a pair of right and left lower trailing arms 34, and a lateral rod 36, between the vehicle body 14 and the axle housing 20. In the lateral rod 36, a first end in a vehicle-width direction is coupled to the vehicle body 14 and a second end in the vehicle-width direction is coupled to the axle housing 20, and the lateral rod 36 restricts the movement of the axle housing 20 in the vehicle-width direction. The movement attitude of the axle housing 20 in a front-rear direction and a right-left direction is held by the right and left upper trailing arms 32, the right and left lower trailing arms 34, and the lateral rod 36. Furthermore, to both end portions of the axle housing 20, two intermediate portions of a well-known stabilizer bar link 38 are coupled in a rotatable manner. Right and left end portion of the stabilizer bar link 38 are coupled to the vehicle body 14. The roll (inclination) of the axle housing 20 in the vehicle body 14 is restricted by the stabilizer bar link 38.

The drive device 12 includes a speed reducer 42 that is supported by the vehicle body 14 through a mount 40 and that includes a gear box 42a, an electric motor 43 on a spring-upper side that is couped to the speed reducer 42 and that is supported by the vehicle body 14 through the mount 40, a transmission shaft 44 that transfers drive power from the speed reducer 42 to a final speed reducer 22 on a spring-lower side, the final speed reducer 22 that receives the drive power and that divides the drive power to the right and left drive wheels 18 while allowing the differential between the right and left drive wheels 18, and a pair of driveshafts 26 that transfers the output of the final speed reducer 22 to the right and left drive wheels 18 provided at both ends of the axle housing 20 in a rotatable manner. The speed reducer 42 and the electric motor 43 constitute an electromotive drive unit MDU that is supported by the vehicle body 14.

The electric motor 43 functions as a drive source of the electrified vehicle 10, and is an alternating-current synchronous electric motor, for example. Preferably, the electric motor 43 is a so-called motor generator that functions as an electric motor and an electric generator. The electric motor 43 includes an electric motor case 43a that is supported by the vehicle body 14 through the mount 40 and that is fixed so as to be adjacent to the gear box 42a, a cylindrical stator 43b that is fixed in the electric motor case 43a, a rotor 43c that is disposed on the inside of the stator 43b, and a rotor shaft 43d that is provided in the electric motor case 43a so as to support the rotor 43c in a rotatable manner. A rotation axis C1 of the rotor shaft 43d extends in the right-left direction of the electrified vehicle 10, and the electric motor 43 is a so-called transversely-installed electric motor.

The speed reducer 42 includes the gear box 42a, an input shaft 42b that is protruded from the gear box 42a and that is concentrically coupled to the rotor shaft 43d of the electric motor 43, and an output shaft 42c that is protruded from the gear box 42a to the electric motor 43 side parallel to the input shaft 42b. An input gear 42g1 fixed to the input shaft 42b and an output gear 42g2 fixed to the output shaft 42c and having a larger diameter than the input gear 42g1 engage with each other through an idler gear 42gi. The speed reducer 42 reduces the speed of the rotation of the electric motor 43, and outputs the rotation from the output shaft 42c. The speed reducer 42 includes the input shaft 42b that is protruded to the electric motor 43 side and that is coupled to the electric motor 43 and the output shaft 42c that is protruded to the electric motor 43 side and that is coupled to a first end of the transmission shaft 44 on the vehicle body 14 side. Thereby, in the speed reducer 42, the dynamic power from the electric motor 43 is turned back and is transferred to the transmission shaft 44 on the same side as the input shaft 42b, and therefore, there is an advantage in that downsizing can be performed not only in the front-rear direction of the electrified vehicle 10 but also in the right-left direction of the electrified vehicle 10.

In the width direction of the vehicle body 14, that is, in the right-left direction in FIG. 1, the final speed reducer 22 is disposed on the right side of a center line CL in the vehicle-width direction, that is, on the opposite side from the electromotive drive unit MDU. As a result, in the vehicle-width direction of the vehicle body 14, a space on the left side of the center line CL in the vehicle-width direction, that is, a space on the electromotive drive unit MDU side is larger than a space on the right side, that is, a space on the opposite side from the electromotive drive unit MDU. Thereby, a space that is broad as a whole is formed on the electromotive drive unit MDU side from a large-diameter portion 20a of the axle housing 20 that houses the final speed reducer 22. There is an advantage in that the electromotive drive unit MDU and the transmission shaft 44 are disposed in the space.

The final speed reducer 22 includes a speed reduction mechanism 50 and a differential gear mechanism 52 in the axle housing 20. The differential gear mechanism 52 includes a pair of side gears 54, 56 to which the driveshafts 26 are coupled in the axle housing 20, and a differential case 60. The differential case 60 is provided so as to be capable of rotating around a rotation axis C2 of the side gears 54, 56. The differential case 60 supports a pinion 58 in a rotatable manner. In a state where the differential case 60 houses the side gears 54, 56, the pinion 58 is disposed between the side gears 54, 56, and engages with the side gears 54, 56.

The speed reduction mechanism 50 is constituted by a pair of cylindrical gears: a ring gear 62 that is fixed to the differential case 60 and that has larger diameter and an input gear 64 that is provided around a rotation axis parallel to the rotation axis C2 of the side gears 54, 56 and that has a smaller diameter than the ring gear 62. The axle housing 20 has a pipe shape and includes the large-diameter portion 20a that houses the final speed reducer 22 and a small-diameter portion 20b that houses the driveshafts 26. The large-diameter portion 20a locally has a larger diameter than the small-diameter portion 20b, and houses the speed reduction mechanism 50 and the differential gear mechanism 52. At least a largest-diameter site of the large-diameter portion 20a is positioned on the right side of the center line CL in the vehicle-width direction of the vehicle body 14, that is, on the opposite side from the electromotive drive unit MDU. At least the largest-diameter site of the large-diameter portion 20a is positioned so as not to overlap with the electromotive drive unit MDU in the front-rear direction of the vehicle body 14. The large-diameter portion 20a houses a lubricant F that lubricates the speed reduction mechanism 50 and the differential gear mechanism 52. As the lubricant F, a lubricant having a lower viscosity than a hypoid lubricant that is used when the ring gear 62 and the input gear 64 are hypoid gears is used.

For restraining the torque variation of the transfer torque of the transmission shaft 44, the first end of the transmission shaft 44 on the vehicle body 14 side is coupled to the output shaft 42c of the speed reducer 42 through a vehicle-body-side constant-velocity joint 66, and a second end of the transmission shaft 44 on the axle housing 20 side is coupled through an axle-housing-side constant-velocity joint 68. The vehicle-body-side constant-velocity joint 66 functions as a first joint, and the axle-housing-side constant-velocity joint 68 functions as a second joint. A sliding constant-velocity joint that can extend and contract in the axis direction is used as at least one of the vehicle-body-side constant-velocity joint 66 and the axle-housing-side constant-velocity joint 68, preferably, as vehicle-body-side constant-velocity joint 66. For example, a Barfield constant-velocity joint, a Rzeppa constant-velocity joint, a tri-port constant-velocity joint, or the like is used as the vehicle-body-side constant-velocity joint 66 and the axle-housing-side constant-velocity joint 68.

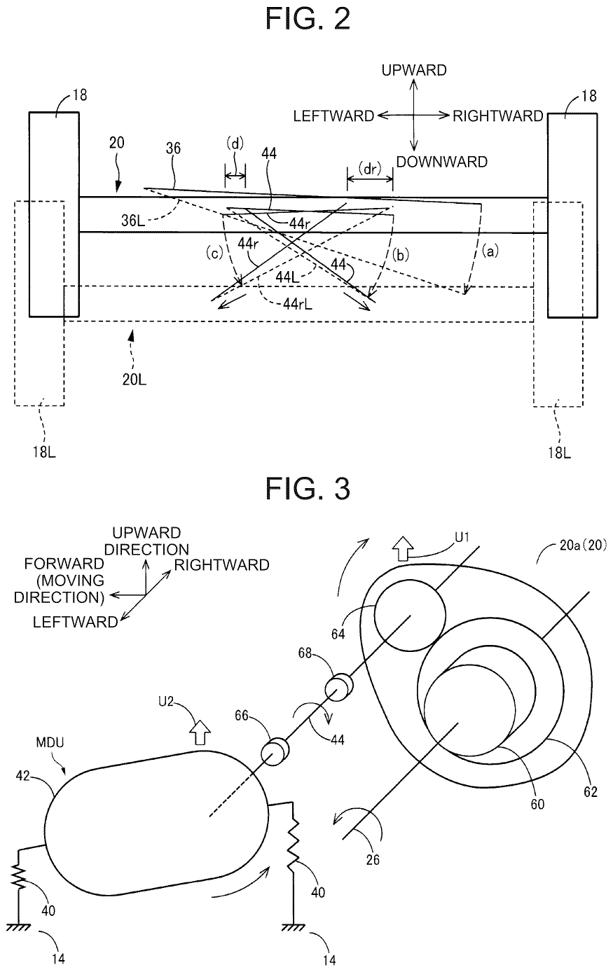

FIG. 2 is an axle rear view, and the transmission shaft 44 when the vehicle-body-side constant-velocity joint 66 is a sliding constant-velocity joint and the axle-housing-side constant-velocity joint 68 is a non-sliding constant-velocity joint is shown by a straight line that uses a length including the vehicle-body-side constant-velocity joint 66 and the axle-housing-side constant-velocity joint 68. FIG. 2 shows the pivot action of the transmission shaft 44 when the drive wheels 18 and the axle housing 20 in a standard state fall to positions shown by drive wheels 18L and an axle housing 20L by the maximal extension of the coil spring 30 due to full rebound during the traveling of the electrified vehicle 10. As for the lateral rod 36 in which the vehicle body 14 side (left end side) is constrained similarly to the transmission shaft 44, an end portion on the axle housing 20 side pivots clockwise to a position shown by a lateral rod 36L while the left end is adopted as the pivot point, as shown by an arc-shaped broken line (a). Thereby, the right end of the lateral rod 36 that is coupled to the axle housing 20 moves to the left side with the falling of the axle housing 20 and the drive wheels 18.

Similarly to the pivot of the lateral rod 36, an end portion of the transmission shaft 44 on the speed reduction mechanism 50 side pivots clockwise to a position shown by a transmission shaft 44L, as shown by an arc-shaped broken line (b). The distance between the output shaft 42c of the speed reducer 42 and the input gear 64 of the speed reduction mechanism 50 increases due to the falling of the axle housing 20, but the increase in the distance is offset by the leftward movement of the axle housing 20. Thereby, an extension amount (d) of the transmission shaft 44L is smaller compared to a case where the electromotive drive unit MDU constituted by the speed reducer 42 and the electric motor 43 is disposed on the right side of the final speed reducer 22 and a right-side end portion of the transmission shaft 44 is constrained on the vehicle body 14 side inversely with the lateral rod 36. The extension amount (d) of the transmission shaft 44L in FIG. 2 corresponds to an extension distance between the output shaft 42c of the speed reducer 42 and the input gear 64 of the speed reduction mechanism 50 when the drive wheels 18 and the axle housing 20 fall from the standard state to the maximal-extension positions shown by the drive wheels 18L and the axle housing 20L.

The extension amount (d) of the transmission shaft 44L is the same even when the axle-housing-side constant-velocity joint 68 of the vehicle-body-side constant-velocity joint 66 and the axle-housing-side constant-velocity joint 68 is a sliding constant-velocity joint. When the extension amount (d) of the transmission shaft 44 is small in this way, the extension-contraction amount of the vehicle-body-side constant-velocity joint 66 or axle-housing-side constant-velocity joint 68 provided on the transmission shaft 44 is reduced, and durability is obtained. Further, there is an advantage in that the axis-directional size of an outer race of the vehicle-body-size constant-velocity joint 66 or the axle-housing-size constant-velocity joint 68 decreases and a maximal crossing angle increases.

In FIG. 2, as a comparative example, the electromotive drive unit MDU constituted by the speed reducer 42 and the electric motor 43 is disposed at a position on the right side of the final speed reducer 22 in the right-left direction of the vehicle body 14, and a transmission shaft 44r in which a right-side end portion is constrained on the vehicle body 14 side inversely with the lateral rod 36 and a broken line (c) showing a position when the transmission shaft 44r pivots counterclockwise to a position shown by a transmission shaft 44rL are shown. An extension amount (dr) in FIG. 2 shows an increase amount of the distance between the output shaft 42c of the speed reducer 42 and the input gear 64 of the speed reduction mechanism 50 when the drive wheels 18 and the axle housing 20 fall from standard state to maximal extension positions, that is, an extension amount (dr) of the transmission shaft 44r. The extension amount (dr) in the case of the comparative example is considerably larger than the extension amount (d), because of the addition of the leftward movement distance of the axle housing 20.

FIG. 3 is a simplified perspective view of the drive device 12 for describing the action of the drive device 12. As shown in FIG. 3, at the time of traveling, a rotation direction RD44 of the transmission shaft 44 coupled to the input gear 64 is the reverse direction of a rotation direction RD26 of the driveshaft 26 coupled to the ring gear 62. When drive power is generated in a forward movement direction, although a front end of the axle housing 20 moves upward as shown by a displacement U1, a rear end of the electromotive drive unit MDU installed on the vehicle body 14 side also moves upward as shown in a displacement U2. Therefore, the increase in the height difference between both ends of the transmission shaft 44 at the time of vehicle traveling is restrained, and therefore, the deterioration of the vehicle-body-side constant-velocity joint 66 and axle-housing-side constant-velocity joint 68 at both ends of the transmission shaft 44 is restrained.

As described above, in the drive device 12 of the electrified vehicle 10 in the first embodiment, the transmission shaft 44 that transmits dynamic power from the electromotive drive unit MDU to the final speed reducer 22 is disposed in the vehicle-width direction, the first end of the transmission shaft 44 in the vehicle-width direction is coupled to the electromotive drive unit MDU through the vehicle-body-side constant-velocity joint (first joint) 66, and the second end of the transmission shaft 44 in the vehicle-width direction is coupled to the final speed reducer 22 through the axle-housing-side constant-velocity joint (second joint) 68. Thereby, in the electrified vehicle 10, a space for disposing a traveling battery is sufficiently obtained under a floor of the vehicle body 14, compared to a case where the transmission shaft 44 is disposed in the vehicle front-rear direction.

Further, in the drive device 12 of the electrified vehicle 10 in the first embodiment, the suspension spring through which the axle housing 20 supports the vehicle body 14 is the coil spring 30, the movement of the axle housing 20 in the vehicle-width direction is restricted by the lateral rod 36 in which the first end in the vehicle-width direction on the same side as the first end of the transmission shaft 44 is coupled to the vehicle body 14 and the second end in the vehicle-width direction on the same side as the second end of the transmission shaft 44 is coupled to the axle housing 20. Thereby, for both of the lateral rod 36 and the transmission shaft 44, the first ends (the left side in FIG. 1) in the vehicle-width direction are supported by the vehicle body 14 that is the spring-upper member, and the second ends (the right side in FIG. 1) are supported by the axle housing 20 that is the spring-lower member. Thereby, the extension-contraction amount of the vehicle-body-side constant-velocity joint (first joint) 66 or axle-housing-side constant velocity joint (second joint) 68 provided on the transmission shaft 44 is restrained, and durability is obtained. Further, there is an advantage in that the axis-directional size of the outer race of the vehicle-body-side constant-velocity joint 66 or axle-housing-side constant-velocity joint 68 decreases and the maximal crossing angle increases.

Further, in the drive device 12 of the electrified vehicle 10 in the first embodiment, the final speed reducer 22 includes the differential gear mechanism 52 that distributes dynamic power to the right and left drive wheels 18 through the driveshafts 26 respectively, and the speed reduction mechanism 50 that is constituted by the large-diameter ring gear 62 and the input gear 64 that are the cylindrical gears provided around the rotation axis C2 of the differential gear mechanism 52 and the rotation axis C3 parallel to the rotation axis C2 of the differential gear mechanism 52 respectively, and the rotation direction RD44 of the transmission shaft 44 is the reverse direction of the rotation direction RD26 of the driveshafts 26. Thereby, when drive power is generated in the forward movement direction, although the front end of the axle housing 20 moves in the upward direction U1, the rear end of the electromotive drive unit MDU installed on the vehicle body 14 side also moves in the upward direction U2. Thereby, the increase in the height difference of the transmission shaft 44 at the time of vehicle traveling is restrained, and therefore, the deterioration of the vehicle-body-side constant-velocity joint 66 and axle-housing-side constant-velocity joint 68 at both ends of the transmission shaft 44 can be restrained.

Further, in the drive device 12 of the electrified vehicle 10 in the first embodiment, the final speed reducer 22 includes the speed reduction mechanism 50 constituted by the ring gear 62 and the input gear 64 that are the cylindrical gears provided around the rotation axis C2 of the differential gear mechanism 52 and the rotation axis parallel to the rotation axis C2 of the differential gear mechanism 52 respectively. Thereby, tooth flank loss is lower and transmission efficiency is higher, compared to a speed reduction mechanism 50 of the final speed reducer 22 that uses a hypoid gear.

Further, in the drive device 12 of the electrified vehicle 10 in the first embodiment, the speed reducer 42 includes the input shaft 42b that is protruded to the electric motor 43 side and that is coupled to the electric motor 43 and the output shaft 42c that is protruded to the electric motor 43 side and that is coupled to the first end of the transmission shaft 44 in the vehicle-width direction. Thereby, in the speed reducer 42, the dynamic power from the electric motor 43 is turned back, and is transferred to the transmission shaft 44, and therefore, downsizing can be performed not only in the front-rear direction of the vehicle but also in the right-left direction of the vehicle.

Further, in the drive device 12 of the electrified vehicle 10 in the first embodiment, the first end of the transmission shaft 44 in the vehicle-width direction is coupled to the electromotive drive unit MDU through the vehicle-body-side constant-velocity joint 66, the second end of the transmission shaft 44 in the vehicle-width direction is coupled to the final speed reducer 22 through the axle-housing-side constant-velocity joint 68, and at least one of the vehicle-body-side constant-velocity joint 66 and the axle-housing-side constant-velocity joint 68 is a sliding constant-velocity joint that allows slide in the axis direction. Therefore, the transmission shaft 44 makes it possible to restrain torque variation. Incidentally, in the case where the vehicle-body-side constant-velocity joint 66 and the axle-housing-side constant-velocity joint 68 are Cardan joints, the torque variation is cancelled by disposing one Cardan joint such that the phase angle is shifted by 90° relative to the other Cardan joint. However, in the case where crossing angles at both ends of the transmission shaft 44 are different, the torque variation cannot be cancelled.

Further, in the drive device 12 of the electrified vehicle 10 in the first embodiment, the final speed reducer 22 is lubricated with the lubricant F that has a lower viscosity than the hypoid gear lubricant. Thereby, it is possible to use an ATF for the cylindrical gear that has a low viscosity, as the lubricant F for lubricating the final speed reducer 22, and to lessen dynamic power loss.

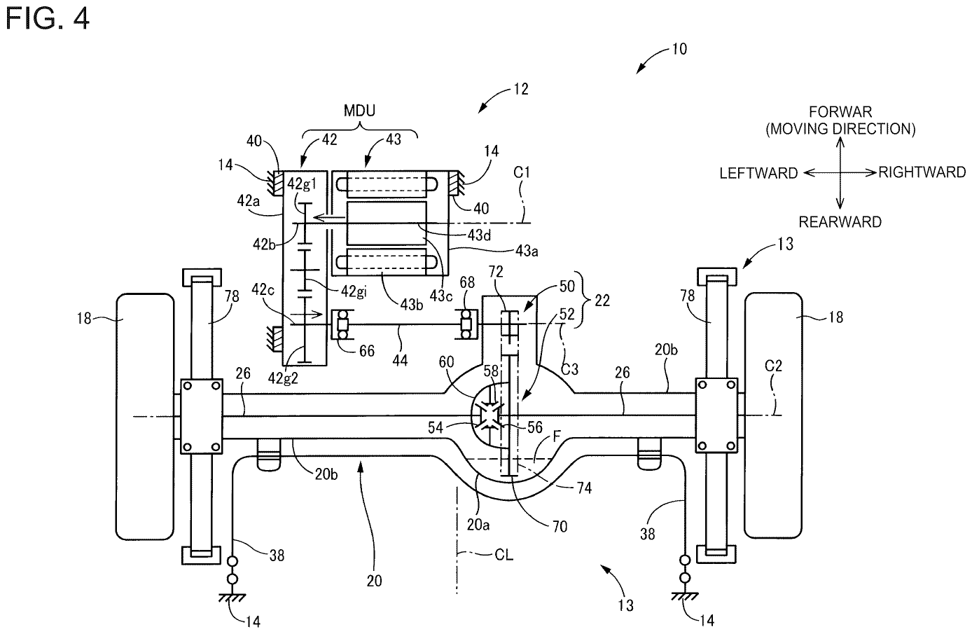

Next, the second embodiment of the present disclosure will be described with use of FIG. 4. Parts in common with the first embodiment are denoted by identical reference characters, and descriptions are omitted. Differences from the first embodiment shown in FIG. 1 will be described below.

In FIG. 4, the speed reduction mechanism 50 of the final speed reducer 22 is a chain type speed reducer including a large-diameter sprocket 70 that is fixed to the differential case 60, a small-diameter sprocket 72 that is provided around the rotation axis C3 parallel to the rotation axis C2 of the side gears 54, 56 and that has a smaller diameter than the large-diameter sprocket 70, and a transmission chain 74 that is wound around the large-diameter sprocket 70 and the small-diameter sprocket 72.

The electrified vehicle 10 supports the vehicle body 14 through a pair of leaf springs 78 that suspends the vehicle body 14 in a vertically movable manner. Both end portions of each leaf spring 78 in a longitudinal direction of the leaf spring 78 are coupled to the vehicle body 14, and a central portion of the leaf spring 78 is fixed to the axle housing 20. The leaf spring 78 is constituted by a single long-plate-shaped spring or a plurality of laminated long-plate-shaped springs having different lengths, and therefore. The movement attitude of the axle housing 20 in the vertical direction and the right-left direction is held. Therefore, the right and left upper trailing arms 32, the right and left lower trailing arms 34, and the lateral rod 36 are not attached. The stabilizer bar link 38 is used as necessary, for restricting the inclination of the vehicle body 14.

In the second embodiment, the transmission shaft 44 that transmits dynamic power from the electromotive drive unit MDU to the final speed reducer 22 is disposed in the vehicle-width direction, the first end of the transmission shaft 44 in the vehicle-width direction is coupled to the electromotive drive unit MDU through the vehicle-body-side constant-velocity joint (first joint) 66, and the second end of the transmission shaft 44 in the vehicle-width direction is coupled to the final speed reducer 22 through the axle-housing-side constant-velocity joint (second joint) 68 and is disposed in the width direction of the vehicle body 14. Thereby, the same effects as the first embodiment are obtained. For example, the space for disposing the traveling battery is sufficiently obtained under the floor of the vehicle body 14, compared to the case where the transmission shaft 44 is disposed in the vehicle front-rear direction.

Further, in the drive device 12 of the electrified vehicle 10 in the second embodiment, the final speed reducer 22 includes the speed reduction mechanism 50 constituted by the large-diameter sprocket 70 and small-diameter sprocket 72 that are provided around the rotation axis C2 of the differential gear mechanism 52 and the rotation axis C3 parallel to the rotation axis C2 of the differential gear mechanism 52 respectively and the transmission chain 74 that is wound around the large-diameter sprocket 70 and the small-diameter sprocket 72. Thereby, tooth flank loss is lower and transmission efficiency is higher, compared to a speed reduction mechanism 50 of the final speed reducer 22 that uses a hypoid gear.

The first embodiment and the second embodiment as examples of the present disclosure have been described above based on the drawings. However, the present disclosure can be applied to other aspects.

For example, in each drive device 12 in the first embodiment and the second embodiment, as shown in FIG. 1 and FIG. 4, the left end of the transmission shaft 44 in the vehicle-width direction is coupled to the electromotive drive unit MDU through the vehicle-body-side constant-velocity joint (first joint) 66, and the right end of the transmission shaft 44 in the vehicle-width direction is coupled to the final speed reducer 22 through the axle-housing-side constant-velocity joint (second joint) 68. However, the drive device 12 may have a configuration that is horizontally flipped with respect to the center line CL. In this case, for example, the right end of the transmission shaft 44 in the vehicle-width direction is coupled to the electromotive drive unit MDU through the vehicle-body-side constant-velocity joint (first joint) 66, and the left end of the transmission shaft 44 in the vehicle-width direction is coupled to the final speed reducer 22 through the axle-housing-side constant-velocity joint (second joint) 68.

Further, in the first embodiment and the second embodiment, the vehicle-body-side constant-velocity joint 66 provided at the left end of the transmission shaft 44 in the vehicle-width direction and the axle-housing-side constant-velocity joint 68 provided at the right end of the transmission shaft 44 in the vehicle-width direction do not always need to be constant-velocity joints, and may be universal joints, such as Cardan joints.

Further, the first embodiment adopts a five-link type suspension device in which the coil spring 30, the right and left upper trailing arms 32, the right and left lower trailing arms 34, and the lateral rod 36 are provided between the vehicle body 14 and the axle housing 20. However, three-link type or four-link type suspension device in which one of the upper trailing arms 32 and/or one of the right and left lower trailing arms 34 is excluded may be adopted.

Further, each electrified vehicle 10 in the first embodiment and the second embodiment is a vehicle that travels by adopting the electric motor 43 as a drive source, and for example, may be an electrified vehicle (BEV) in which the rear wheels are the drive wheels 18 and only the electric motor 43 is adopted as the drive source using the electric power stored in a battery, a four-wheel-drive electrified vehicle in which another electric motor drives the front wheels in addition of the drive of the rear wheels by the electric motor 43, or a series traveling vehicle in which the electric motor 43 is driven by the electric power generated by an internal combustion engine. Further, the electrified vehicle 10 may be a four-wheel-drive hybrid electric vehicle (HEV) in which the front wheels are driven by an internal combustion engine and first and second electric motors that are coupled by a dynamic power distribution mechanism or the front wheels are driven by an internal combustion engine and a first electric motor that are coupled through a connection-disconnection clutch and in which the rear wheels are driven by the drive device 12 shown in FIG. 1.

Further, even when an internal combustion engine is equipped in the drive device 12 in FIG. 1 instead of the electric motor 43, the effect of sufficiently obtaining the space for disposing the traveling battery under the floor of the vehicle body 14 is obtained similarly to the first embodiment.

The above-described embodiments are examples of the present disclosure, and the present disclosure can be carried out as aspects in which various modifications and improvements are made based on the knowledge of a person skilled in the art without departing from the spirit of the present disclosure.

What is claimed is:

1. A drive device of a rigid-axle electrified vehicle, the drive device comprising:
an electromotive drive unit provided in a vehicle body;
a final speed reducer configured to divide dynamic power from the electromotive drive unit to right and left drive wheels;
an axle housing configured to couple the right and left drive wheels and to house the final speed reducer; and
a transmission shaft configured to transmit dynamic power from the electromotive drive unit to the final speed reducer, wherein:
the axle housing is configured to support the vehicle body through a suspension spring;
the transmission shaft is disposed in a vehicle-width direction of the vehicle body;
a first end of the transmission shaft in the vehicle-width direction is coupled to the electromotive drive unit through a first joint; and
a second end of the transmission shaft in the vehicle-width direction is coupled to the final speed reducer through a second joint.

2. The drive device according to claim 1, wherein:
the suspension spring is a pair of coil springs;
movement of the axle housing in the vehicle-width direction is restricted by a lateral rod, a first end of the lateral rod in the vehicle-width direction being coupled to the vehicle body, a second end of the lateral rod in the vehicle-width direction being coupled to the axle housing; and
the lateral rod and the transmission shaft are configured to pivot in an identical direction in connection with vertical motion of the vehicle body.

3. The drive device according to claim 1, wherein:
the final speed reducer includes a differential gear mechanism and a speed reduction mechanism, the differential gear mechanism being configured to distribute dynamic power to the right and left drive wheels through a pair of driveshafts, respectively, the speed reduction mechanism being a pair of cylindrical gears provided around a rotation axis of the differential gear mechanism and a rotation axis parallel to the rotation axis of the differential gear mechanism, respectively; and
a rotation direction of the transmission shaft is a reverse direction of a rotation direction of the driveshafts.

4. The drive device according to claim 3, wherein the final speed reducer is lubricated with a lubricant that has a lower viscosity than a hypoid gear lubricant.

5. The drive device according to claim 3, wherein:
the axle housing includes a pair of small-diameter portions configured to house the driveshafts, and a large-diameter portion provided between the pair of small-diameter portions and configured to house the speed reduction mechanism and the differential gear mechanism; and
at least a largest-diameter site of the large-diameter portion is positioned so as not to overlap with the electromotive drive unit in a vehicle moving direction.

6. The drive device according to claim 1, wherein the final speed reducer includes a differential gear mechanism and a speed reduction mechanism, the differential gear mechanism being configured to distribute dynamic power to the right and left drive wheels through driveshafts, respectively, the speed reduction mechanism including a pair of sprockets provided around a rotation axis of the differential gear mechanism and a rotation axis parallel to the rotation axis of the differential gear mechanism, respectively, and a transmission chain wound around the sprockets.

7. The drive device according to claim 6, wherein the final speed reducer is lubricated with a lubricant that has a lower viscosity than a hypoid gear lubricant.

8. The drive device according to claim 1, wherein:
the final speed reducer includes a speed reduction mechanism, and a differential gear mechanism configured to transfer dynamic power from the speed reduction mechanism to the right and left drive wheels through driveshafts, respectively;
the axle housing includes a pair of small-diameter portions configured to house the driveshafts, and a large-diameter portion provided between the pair of small-diameter portions and configured to house the speed reduction mechanism and the differential gear mechanism; and
at least a largest-diameter site of the large-diameter portion is positioned so as not to overlap with the electromotive drive unit in a vehicle moving direction.

9. The drive device according to claim 1, wherein:
the electromotive drive unit includes an electric motor and a speed reducer configured to reduce a speed of rotation of the electric motor; and
the speed reducer includes an input shaft protruded to a side of the electric motor and coupled to the electric motor and an output shaft protruded to the side of the electric motor and coupled to the first end of the transmission shaft in the vehicle-width direction.

10. The drive device according to claim 1, wherein:
each of the first joint and the second joint is a constant-velocity joint; and
at least one of the first joint and the second joint is a sliding constant-velocity joint that is configured to allow slide in an axis direction.

11. The drive device according to claim 1, wherein:
the suspension spring is a pair of leaf springs each of which is constituted by a single plate-shaped spring or a plurality of laminated plate-shaped springs, both end portions of each member in a longitudinal direction of the member being coupled to the vehicle body, a central portion of each member in the longitudinal direction being coupled to the axle housing; and
movement of the axle housing in a vertical direction and the vehicle-width direction is restricted by the pair of leaf spring.
